(19) United States
(12) Patent Application Publication
(10) Pub. No.: US 2024/0201930 A1
(43) Pub. Date: Jun. 20, 2024

(54) METHOD AND SYSTEM FOR PROVIDING A CONTENT SHARING WINDOW

(71) Applicant: Microsoft Technology Licensing, LLC, Redmond, WA (US)

(72) Inventor: Juan Antonio Sanchez, Redmond, WA (US)

(21) Appl. No.: 18/085,017

(22) Filed: Dec. 20, 2022

(51) Int. Cl. G06F 3/14; G06F 3/0482; H04L 65/1089; H04L 65/403; H04L 65/80

(52) U.S. Cl. CPC G06F 3/1454; G06F 3/0482; H04L 65/1089; H04L 65/403; H04L 65/80

(57) ABSTRACT

A method for screen sharing data during a network-based communication session is provided. A command to share content in an application window of an application executing on a first device and separate from a network-based communication application providing the network-based communication session is identified. Data of the application window is analyzed to determine that the application window includes a first portion that displays the content and a second portion that displays user interface controls. The user interface controls take up areas of a user interface of the application where the content is not displayed. A content sharing window is constructed based on the application window by including the first portion in the content sharing window and excluding the second portion from the content sharing window. The constructed content sharing window that includes the first portion but not the second portion is transmitted to the second device via the communication session.

### TECHNICAL FIELD

Examples pertain to data sharing among devices engaged in a network-based communication session. Some examples relate to transmitting a portion of content included in an application window executing on a first device to a second device via the network-based communication session.

### BACKGROUND

Conducting conferences from a user device instead of in person is becoming more commonplace via video conferencing. Oftentimes, discussion during the conference can center around content that is displayed on a computing device of one of the attendees. Thus, the attendee may become a sharer and share the content with the other attendees by allowing the other attendees to view the content.

However, there may be instances where all of the content on the computing device of the sharer does not need to be shared with the other attendees. Accordingly, a need exists for a system and method that can segment portions of content on a computing device of a sharer such that portions of the content are shared with other attendees and portions of the content are not shared with other attendees.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows an environment in which examples may operate, according to some examples of the present disclosure.

FIG. 2 demonstrates a method for providing a content focus mode for screen sharing data during a network-based communication session, according to some examples of the present disclosure.

FIG. 3 illustrates an application window displaying content having a first portion and a second portion, according to some examples of the present disclosure.

FIG. 4 illustrates a content sharing window, according to some examples of the present disclosure.

FIG. 5 is a block diagram illustrating an example of a machine upon which one or more examples may be implemented.

FIG. 6 illustrates a device that can be used to implement exemplary examples of the present disclosure.

### DETAILED DESCRIPTION

Examples relate to a method and system for providing a content focus mode for screen sharing data during a network-based communication session between a first device and a second device. The first device may be executing a content-based application that is separate from a network-based application providing the network-based communication session. A first user at the first device can decide to share content in an application window of the content-based application with the second device. Data of the application window can be analyzed such that a determination can be made that the application window includes a first portion and a second portion.

The first portion can display the content while the second portion can display user interface controls. The content-based application can include a user interface where the user interface controls take up areas of the user interface where the content is not displayed. The user interface controls of the content-based application can manipulate the content opened in the application window and can include a selection menu or control icons. The first device can perform a function when an item of the selection menu or the control icons is selected.

A content sharing window can be constructed based on the application window. In particular, the content in the application window can be segmented such that the content sharing window includes the first portion. Moreover, the content in the application window can be segmented such that the second portion of the content is excluded from content sharing window. Display data of the constructed content sharing window can be transmitted to the second device via the network-based communication session.

As an illustration, a first device may be communicating with a second device using a network-based communication session. A user associated with the first device may have a word processing application open on the first device that displays a document in an application window of the word processing application. The application window of the word processing application can include a user interface having user interface controls that can control the user interface and manipulate the document. The first user may want to share the document with a second user at the second device. The application window of the word processing application having the document can be shared using the network-based communication session. However, when the application window of the word processing application having the document is viewed by the second user at the second device, only the document is displayed to the second user device at the second device. In particular, the user interface controls are not displayed to the second user at the second device. In examples, either a server providing the network-based communication session or the first device can include functionality to perform the operations described herein and construct the content sharing window. As used herein, the content focus mode can refer to displaying a first portion of content opened at the application, i.e., the document, without displaying a second portion, i.e., the user interface controls, at the second device.

Examples address technical problems associated with user interface interaction performance by using the technical solution of image segmentation to produce a more focused interface. Technical problems can arise when content that is being shared includes unnecessary features that can inhibit the ability of a user to quickly access and interact with the content that is being shared. Technical problems can arise when a user interface lists functions, such as user interface controls, that can inhibit reader efficiency, thus minimizing the ability to rapidly access and process the shared content. The disclosed techniques, among other technical improvements, are thus directed to an improved user interface that allows users to more readily identify shared content data by eliminating cluttering user interface elements that are not functional in a network-based meeting. This allows the user to more quickly ascertain the significance of the shared content thereby improving the efficient functioning of the computer. By displaying only the shared content and not the user interface controls, the disclosed techniques allow users to more efficiently navigate to the information that is important and thus provides for rapidly accessing and processing information.

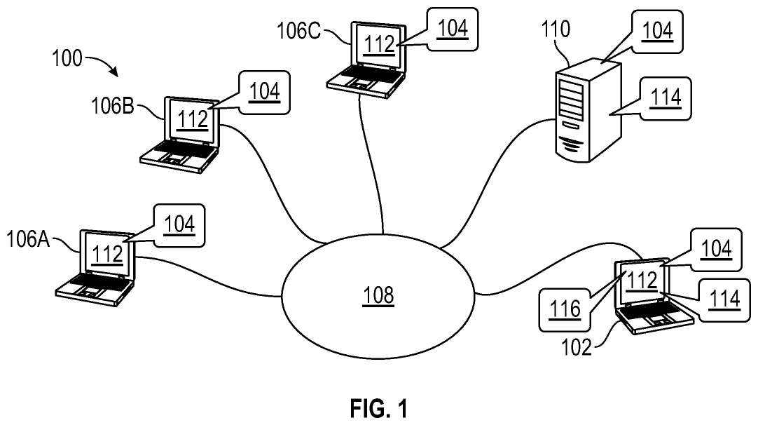

Now making reference to FIG. 1, an environment 100 in which examples may operate is shown. A user associated with a device 102 can execute a network-based communication application, generically shown as 104, which can provide a persistent communication application. The network-based communication application 104 can provide audio and/or video based collaboration with document sharing, virtual meetings, group meetings, and the like between the device 102 and devices 106A-C via a network 108. The network-based communication application 104 can be based locally on the devices 102 and 106A-C. Additionally, a server device 110 can provide the network-based communication application 104 to the devices 102 and 106A-C. An example of the network-based communication application 104 can include Microsoft Teams™.

The devices 102 and 106A-C along with the server device 110 can include any type of computing device, such as a desktop computer, a laptop computer, a tablet computer, a portable media device, or a smart phone. Throughout this document, reference may be made to the device 106 or the devices 106A-C. The term device 106 and the term devices 106A-C are interchangeable with each other.

The network 108 may be any network that enables communication between or among machines, databases, and devices (e.g., the devices 102 and 106A-C). The network 108 can be a packet routing network that can follow the Internet Protocol (IP) and the Transport Control Protocol (TCP). Accordingly, the network 108 can be a wired network, a wireless network (e.g., a mobile or cellular network), or any suitable combination thereof. The network 108 can include one or more portions that constitute a private network, a public network (e.g., the Internet), or any suitable combination thereof.

The device 102 can execute a content-based application 112 that is separate from the network-based communication application 104. Content opened with the content-based application 112 at the device 102 can be shared with the devices 106A-C, where the content-based application 112 along with the media opened within the content-based application 112 can be shared with the devices 106A-C. Examples of the content-based application 112 can include a word processing application, a database application, a spreadsheet application, a presentation application, a multimedia application, or the like. Examples of content opened within the content-based application 112 can include a document, a database, a spreadsheet, a presentation, multimedia, or the like. Further examples of content opened within the content-based application 112 can include video, audio, or a communication text string.

In addition, either the device 102 or the server device 110 can include an application 114. The application 114 can be an algorithm that can perform the operations discussed herein. To further illustrate, the algorithm of the application 114 can be configured to construct a content sharing window that includes various portions of content displayed at the device 102 and excludes various portions of content displayed at the device 102.

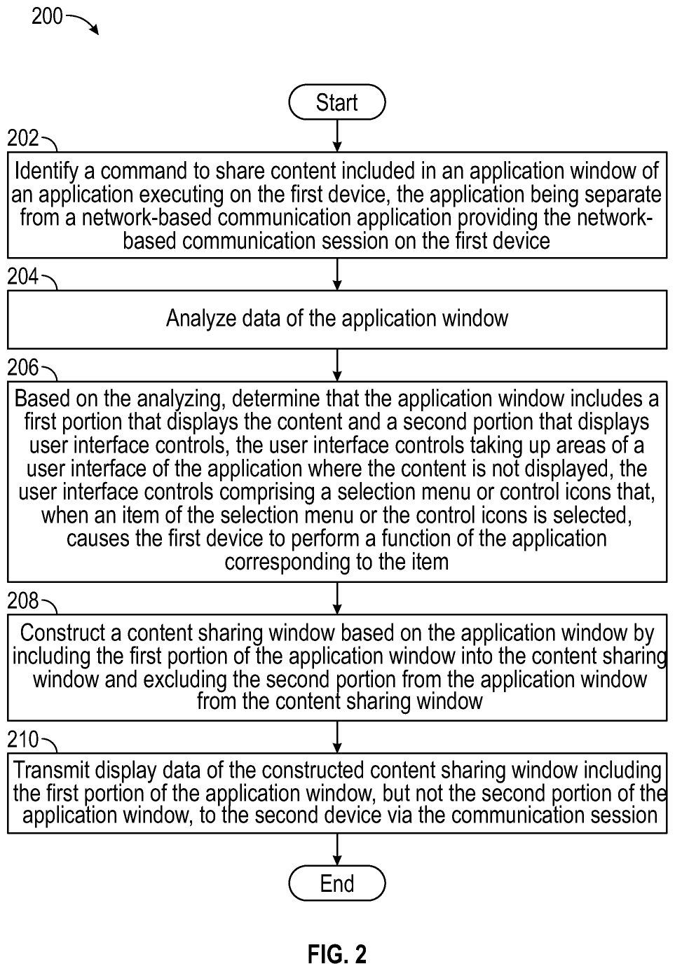

As noted above, examples relate to a method for providing a content focus mode for screen sharing data during a network-based communication session between a first device and a second device. An example of this is shown with reference to FIG. 2 and a method 200. The content focus mode can display shared content without user interface controls during a network-based communication session between a first device and a second device. In an operation 202, the method 200 identifies a command to share content included in an application window executing on a first device. The application can be separate from a network-based communication application that provides the network-based communication session on the first device. The application can provide a user interface where the user interface can display the opened content while also including user interface controls. Here, the network-based communication application can facilitate communication between the first device and the second device. Moreover, the first device can utilize the network-based communication session provided by the network-based communication application to share content included in an application window of an application executing on the first device with a second device.

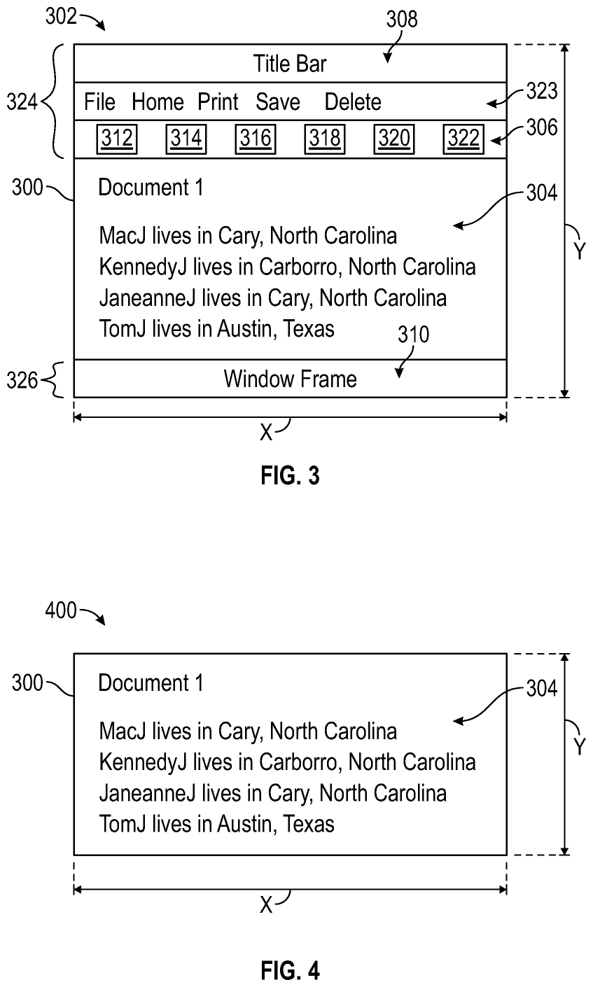

As an example of the method 200 and referred to herein as “the illustration,” reference is made to FIGS. 1 and 3. During the operation 202, the application 114, functioning at either the device 102 or the server device 110, identifies a command to share content 300 included in an application window 302 opened with the content-based application 112. In this illustration, the content-based application 112 is a word processing application and the content 300 is a document opened in the application window 302 of the content-based application 112. In the illustration, a user associated with the device 102 has decided that the content 300 should be shared with the devices 106A-C. The device 102 communicates with the devices 106A-C via the network-based communication application 104, which, in the illustration, is Microsoft Teams™. Therefore, the word processing content-based application 112 is separate and distinct from the network-based communication application 104, which provides a network-based communication session on the device 102.

Returning attention to FIG. 2, after the operation 202, the method 200 performs an operation 204 where data of the application window can be analyzed. The application window can be analyzed to determine if the application window has different portions, where the determination can be made during an operation 206 based on the analysis. A first portion can relate to content displayed by the application window. A second portion can relate to controls that can be used to control the content or the application window.

In instances where the application window is a user interface, the second portion can include user interface controls that can be used to control various aspects of the user interface along with the first portion. The user interface controls can take up areas of the application user interface where the content in the application window is not displayed. The user interface controls can manipulate data within the first portion that displays the content opened in the application window. The user interface controls can include a selection menu or controls icons. When an item of the selection menu or the control icons is selected, the selection causes the first device to perform a function of the application corresponding to the item. Furthermore, the user interface controls can include an application menu bar, a window frame, and/or a title bar. The user interface controls are not limited to the listed items and can include other input controls, navigation components, informational components, containers, and the like.

Turning back to the illustration and FIG. 3, during the operation 204, the application 114 analyzes data of the application window 302 and determines, based on the analysis, that the application window 302 includes a first portion 304 and a selection menu 306, a title bar 308, and a window frame 310. The first portion 304 can include a document titled “Document 1” which has text relating to where users MacJ, KennedyJ, JaneanneJ, and TomJ live. The selection menu 306 can include control icons 312-322 that can provide various types of functionality for the content-based application 112 along with a menu bar 323. In the illustration, examples of the functionality provided by the control icons 312-322 can include save functions, delete functions, copy functions, undo functions, spell check functions, print functions, or the like. Another specific example of this may be the Microsoft Office Ribbon and menu bars. The combination of the selection menu 306, the title bar 308, the window frame 310, and the menu bar 323 can correspond to the second portion. In some examples, docked, or undocked toolbars may be included in the second portion. When one of the control icons 312-322 is selected, such as if the control icon 312 is selected and corresponds to a delete function, selection of the control icon 312 can cause deletion of a portion of the content 300 such as deleting text relating to where the user MacJ lives in the content 300 by the device 102. As may be seen with reference to FIG. 3, the selection menu 306, the title bar 308, the window frame 310, and the menu bar 323 take up areas 324 and 326 of the application window 302. The areas 324 and 326 can correspond to areas where the content 300 is not displayed. During the operation 206, in the illustration, the application 114, operating at either the device 102 or the server device 110, can determine that the application window 302 includes the first portion 304 along with the selection menu 306, the title bar 308, the window frame 310, and the menu bar 323 corresponding to the second portion based on analyzing the data in the operation 204.

Typically, an application screen can include the first portion 304 along with the selection menu 306, the title bar 308, the window frame 310, and the menu bar 323 corresponding to the second portion. However, this type of content can clutter the shared content for users at the devices 106A-C, thereby inhibiting reader efficiency by decreasing the ability to rapidly access and process the content 300 in order to ascertain the significance of the content 300. As will be discussed further on, examples can enlarge the content 300 on the devices 106A-C without the first portion 304 and the selection menu 306, the title bar 308, the window frame 310, and the menu bar 323 corresponding to the second portion such that users at the devices 106A-C can more quickly ascertain the significance of the content 300. Moreover, this can be especially beneficial when the devices 106A-C correspond to devices having small screens, such as a mobile device, a wearable device, and/or the like. The content 300 may be enlarged to fill an entire area designated for display of shared content on the network-based communication application of the recipient by resizing, rescaling, or changing the aspect ratio of the content 300.

Returning to FIG. 2 and the method 200, after the operation 206, the method 200 performs an operation 208, where a content sharing window based on the application window is constructed. Here, the content sharing window can be constructed by including the first portion of the application window into the content sharing window. Moreover, the content sharing window can be constructed by excluding the second portion from the application sharing window from the content sharing window.

The content sharing window can be constructed by segmenting the content opened with an application executing on a device into the first portion and the second portion using any number of ways, such as segmentation algorithms that can include the GrowCut algorithm, the random walker algorithm, or a region-based image segmentation algorithm. In addition, content can be segmented using artificial intelligence (AI), obtaining information from an application programming interface (API) of the content-based application, or the setting of Hypertext Markup Language (HTML) tags in HTML fields of the content-based application. In scenarios where AI is used to segment content opened with an application executing on a device in the first and second portions, AI could be on top of a video feed to recognize certain types of information in the content opened by an application executing on a device. AI can implement character recognition of the video feed, such as the selection menu 306, the title bar 308, the window frame 310, and the menu bar 323 the ai could be trained from the feed that is sent to the end user Character recognition could relate to colors associated with the selection menu 306, the title bar 308, the window frame 310, and the menu bar 323, and/or alphanumeric characters of the selection menu 306, the title bar 308, the window frame 310, and the menu bar 323 could be recognized by AI and learn that these should be removed from the content sharing window 400 to be shared. In particular, AI, such as a neural network, can be trained with training data to recognize visual patterns associated with user interface controls, such as placement, i.e., above and/or below, graphical characteristics of user interface controls, such geometry and size relative to the media opened with the application, and the like. When AI recognizes the visual patterns in the video feed, AI can function to instruct an application, such as the application 114, what content opened with the application should be shared, i.e., the first portion, from the content 300 and what content should be excluded, i.e., the second portion, from the content 300. In addition, AI can be trained over time with additional training data to recognize visual patterns associated with the user interface controls where an algorithm employed by AI can change over time with changing training data such that instructions provided to the application can change over time.

In examples where content opened with an application executing on a device is segmented based on information from APIs of the content-based application 112, the content-based application 112 can know the coordinates within the application window 302 that are dedicated to various elements within the application window 302. For example, the coordinates could correspond to the first portion 304, the selection menu 306, the title bar 308, the window frame 310, and the menu bar 323. The application 114 can use these coordinates to segment the content 300. In particular, the application 114 can receive an instruction indicating that content at the coordinates corresponding to the first portion 304, the selection menu 306, the title bar 308, the window frame 310, and the menu bar 323 should be segmented from the content sharing window 400.content-based application 112. As such, content-based application 112 the application 114 can determine that the second portion defined by the selection menu 306, the title bar 308, the window frame 310, and the menu bar 323 should not be included in the data shared with the devices 106A-C.

In scenarios where content opened with an application executing on a device is segmented based on HTML tags, HTML tags can be set to true in HTML fields indicating that the media should be segmented into the first portion and the second portion. Moreover, HTML flags can be set to true indicating that the second portion of the content opened with an application executing on a device should not be shared. Thus, the application 114 can determine that the content 300 should be segmented into the first portion 304 and the second portion defined by the selection menu 306, the title bar 308, and the window frame 310. Additionally, based on the HTML tags, the application 114 can determine that the second portion defined by the selection menu 306, the title bar 308, the window frame 310, and the menu bar 323 should be excluded from data shared with the devices 106A-C. The content sharing window can be constructed by segmenting the content opened with an application executing on a device into the first portion and the second portion with the application 114 operating at either the device 102 or the server device 110. Thus, segmentation can be local to the user sharing the content or remote from the user sharing the content.

Still staying with FIG. 2 and the method 200, after constructing the content sharing window, the display data of the constructed content sharing window is transmitted to the second device via the communication session during an operation 210. The constructed content sharing window can include the first portion of the application window. However, the constructed content sharing window that is displayed at the second device may not include the second portion of the application window.

Referring once again to the illustration and FIG. 3 along with FIG. 4, in the operation 206, the selection menu 306, the title bar 308, the window frame 310, and the menu bar 323 were identified as the second portion of the content 300. Therefore, during the operation 208, the application 114 operating at the server device 110 can remove the selection menu 306, the title bar 308, the window frame 310, and the menu bar 323 from the content transmitted from the device 102 while constructing a content sharing window 400 during the operation 208. In the illustration, the application 114 can read HTML tags associated with the content 300 and the application window 302. The HTML tags can be set to true indicating that the selection menu 306, the title bar 308, the window frame 310, and the menu bar 323 should be removed during construction of the content sharing window 400. Thus, the selection menu 306, the title bar 308, the window frame 310, and the menu bar 323 are excluded from the content sharing window 400 and instead, only the first portion 304 of the content 300 will be displayed at the devices 106A-C.

Here, once the server device 110 constructs the content sharing window 400, the server device 110 can transmit the content sharing window 400 via a communication session established by the server device 110 between the device 102 and the devices 106A-C. The devices 106A-C can display the content sharing window 400 where only the first portion 304 is displayed on the devices 106A-C without the selection menu 306, the title bar 308, and the window frame 310. In particular, as may be seen with reference to FIG. 4, the media 400 only includes the first portion 304 of the user interface 300 without the selection menu 306, the title bar 308, and the window frame 310. Upon completion of the operation 210, the method 200 is complete.

While the device 102 is shown as sharing content opened with a single application, i.e., the content-based application 112, examples envision scenarios where the device 102 could have two applications, such as the content-based application 112 and an application 116, open, where a user at the device 102 desires to share content opened with both of the applications 112 and 116 via a network-based communication session established with the devices 106A-C as discussed above. For example, in addition to a word processing application, the device 102 can have multimedia content opened with a multimedia application that a user at the device 102 desires to share with the devices 106A-C. Here, the application 114, operating at either the server device 110 or the device 102, can identify a command to share the multimedia content opened with the application 116 as detailed with reference to the operation 202. Similar to the content-based application 112, the application 116 can be separate from the network-based communication application providing the network-based communication session.

In this scenario, the application 114, again operating at either the device 102 or the server device 110, can analyze data of an application window utilized by the application 116, as discussed above with reference to the operation 204. The data can include a first portion and a second portion. The first portion can display the multimedia content opened within the application 116 while the second portion can display second user interface controls as described above. The second user interface controls can include a second selection menu, second control icons, a second window frame, and a second title bar. The user interface controls of the application 116 can take up areas of a second user interface of the application 116 where the multimedia content opened by the application 116 is not displayed, as described above with reference to the content-based application 112.

In scenarios where the device 102 includes the application 116, a second content sharing window can be constructed as discussed above where the second content sharing window can include the first portion that displays the multimedia content opened with the application 116. In addition, the second content sharing window can exclude the second portion of the multimedia content. The second content sharing window can be transmitted to the devices 106A-C via the communication session between the device 102 and the devices 106A-C. The application 114 can be configured to construct the second content sharing window during transmission of the content sharing window described with reference to FIG. 2 or simultaneously with the construction of the content sharing window described with reference to FIG. 2.

Moreover, the content sharing window and the second content sharing window can be stitched together. For example, the content sharing window and the second content sharing window could be stitched together such that the content sharing window and the second content sharing window are side by side. Moreover, the content sharing window and the second content sharing window could be stitched together such that the content sharing window and the second content sharing window can have a top and bottom configuration. In the top and bottom configuration, one of the content sharing window and the second content sharing window could be on top of the other of the content sharing window and the second content sharing window. Furthermore, the content sharing window and the second content sharing window could have an offset configuration where in either the side by side or top and bottom configurations, the content sharing window and the second content sharing window could be offset from each other.

In examples, a user at the device 102 can specify that only the first portion 304 and not the selection menu 306, the title bar 308, the window frame 310, and the menu bar 323 should be displayed at the devices 106A-C. Here, an instruction can be received at the device 102 or at the server device 110 indicating only the first portion 304 and not the selection menu 306, the title bar 308, the window frame 310, and the menu bar 323 should be displayed at the devices 106A-C. Moreover, an instruction can be received where one of the selection menu 306, the title bar 308, the window frame 310, and the menu bar 323 can be displayed at the devices 106A-C or any combination thereof while others of the selection menu 306, the title bar 308, the window frame 310, and the menu bar 323 not in the combination should not be displayed at the devices 106A-C. To further illustrate, an instruction can be received from a user at the device 102 that only the selection menu 306 should be displayed while the title bar 308 and the window frame 310 should not be displayed.

In addition, a user can specify that some of the devices 106A-C should receive both the first portion 304 and the selection menu 306, the title bar 308, and the window frame 310. Here, a first instruction can be received at the device 102 or at the server device 110 indicating only the first portion 304 and not the selection menu 306, the title bar 308, the window frame 310, and the menu bar 323 should be displayed at the devices 106A and 106B. Furthermore, a second instruction can be received at the device 102 or at the server device 110 indicating that the first portion 304 along with the selection menu 306, the title bar 308, the window frame 310, and the menu bar 323 i.e., the second portion, should be displayed at the device 106C. In this scenario, separate content sharing windows can be constructed based on the first and second instructions.

In the scenario where the third device 106C displays the first portion 304 along with the selection menu 306, the title bar 308, the window frame 310, and the menu bar 323, a user associated with the third device 106C can engage one of the selection menu 306, the title bar 308, the window frame 310, and the menu bar 323 in order to send a command to the content-based application 112. Upon receiving the command, the content-based application 112 can authorize the user associated with the device 106C to engage one of the selection menu 306, the title bar 308, the window frame 310, and the menu bar 323 in order to manipulate the content 300.

Examples can also relate to carving out (e.g., segmenting) portions of the application window 302 and enlarging the remaining portions of the application window 302 during screen sharing. In particular, the second portion such as the selection menu 306, the title bar 308, the window frame 310, and the menu bar 323, can be carved out of the application window 302 in order to render the content sharing window 400 of FIG. 4 such that the remaining portion, i.e., the first portion 304 is enlarged as to occupy the entire space reserved for content shared from the first device on the other devices in the communication session. That is, the removed elements allow for an increased presentation size of the actual content without showing non-useful elements such as menu bars and window frames. As such, a size of the first portion in the displayed content sharing window 400 can be increased to a size larger than a display size of the first portion 304 in the application window 302 of the application 112 executing on the device 102. This is in contrast to techniques that simply recognize and remove or obfuscate undesirable objects from the scene (such as hung clothes on the wall; confidential contents on whiteboard in the background, etc.) where the scene is not rescaled, not resized, and does not change aspect ratio.

As noted, the application 114 can size the content sharing window 400 such that the content sharing window 400 can occupy an entire area dedicated to content sharing on recipient computing devices. As shown with reference to FIG. 3, the application window 302 can have an area defined by a side X and side Y. During construction of the content sharing window 400 where the selection menu 306, the title bar 308, the window frame 310, and the menu bar 323 are removed, the application 114, or the network-based service can size the content sharing window 400 such that the content sharing window 400 can also have the same area defined by the side X and the side Y. As such, if the space in the GUI of the recipient devices for displaying shared content is also X by Y, the content sharing window 400, as displayed on the recipient devices, can be scaled such that the content sharing window 400 can be of size X and Y. In some examples, if the space in the GUI of the recipient devices for displaying shared content is not X by Y, the recipient computing devices and/or the network-based communication service may rescale the content sharing window. However, the content sharing window 400 may occupy the entire space for displaying shared content from the first device.

For example, if X is 600 and Y is 400 pixels high, the application 104, the network based communication application, or the network based service may remove, from data sent to the recipient device, the image data corresponding to the selection menu 306, the title bar 308, the window frame 310, and the menu bar 323. In addition, the image data sent that corresponds to the first portion 304 may be enlarged to fill the full 600×400 resolution. This size is then sent to the recipient computing device, which may then resize this to fit into the area designated for sharing content from the application 104. For example, if the area designated by the recipient device for sharing content from the application is 300×200 the first portion 304 is resized from 600×400 to 300×200. In another example, if the area designated for sharing content from the application 104 on a recipient device is 1200×800, the received 600×400 image is rescaled by 2× to fit the entire 1200×800 area.

This can be beneficial in scenarios where the devices 106A-C have smaller screens, such as if the devices are hand-held or wearable computing devices, thereby easing the ability of users associated with the devices 106A-C to rapidly ascertain the significance of the content 300 and improving the functioning of the devices 106A-C. The application 114 can implement various interpolation methods, such as bicubic, bilinear, edge-directed, Fourier-based, or Nearest neighbor interpolation to size the content sharing window 400 to have the same area as the application window 302. The application 114 can also implement pixel-art scaling algorithms to size the content sharing window 400.

In order to perform this resizing, the content focus mode can perform an enlarging or rescaling operations such as the aforementioned bicubic, bilinear, edge-directed, Fourier-based, or Nearest neighbor interpolation algorithms. In other examples, the content focus mode can adjust the aspect ratio after the second portion is removed.

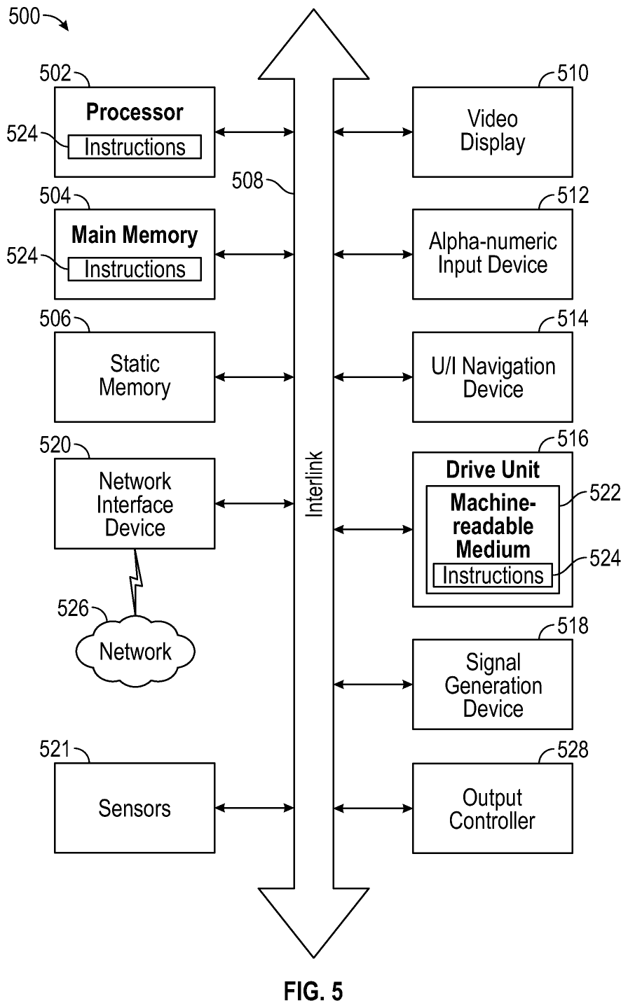

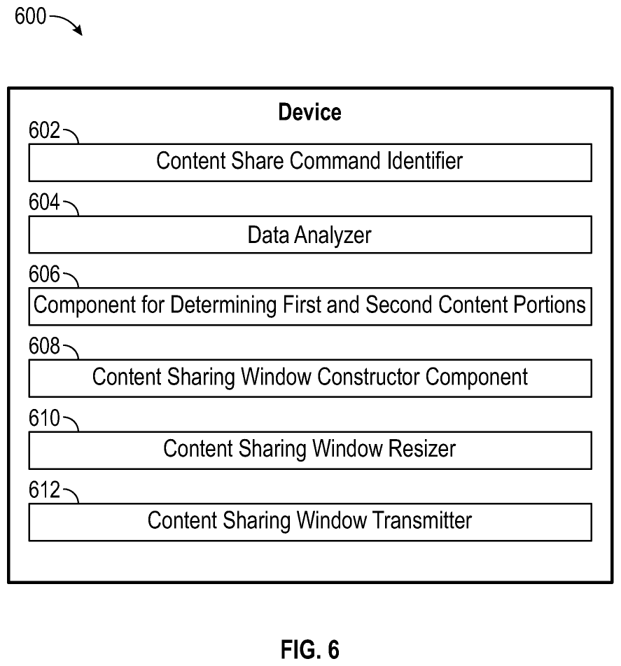

FIG. 5 illustrates a block diagram of an example machine 500 upon which any one or more of the techniques (e.g., methodologies) discussed herein may be performed. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be in the form of a server computer, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Machine 500 may be configured to provide the functionality of the various devices described with reference to FIG. 1; identify share content commands as described above; analyze data associated with application windows as described above with reference to FIGS. 1-3; determine that the application window includes first and second portions, construct a content sharing window based on the application window as described above; and transmit the constructed content sharing window, also as described above. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on one or more logic units, components, or mechanisms (hereinafter “components”). Components are tangible entities (e.g., hardware) capable of performing specified operations and may be configured or arranged in a certain manner. In an example, circuits may be arranged (e.g., internally or with respect to external entities such as other circuits) in a specified manner as a component. In an example, the whole or part of one or more computer systems (e.g., a standalone, client or server computer system) or one or more hardware processors may be configured by firmware or software (e.g., instructions, an application portion, or an application) as a component that operates to perform specified operations. In an example, the software may reside on a machine readable medium. In an example, the software, when executed by the underlying hardware of the component, causes the hardware to perform the specified operations of the component.

Accordingly, the term “component” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which component are temporarily configured, each of the components need not be instantiated at any one moment in time. For example, where the components comprise a general-purpose hardware processor configured using software, the general-purpose hardware processor may be configured as respective different components at different times. Software may accordingly configure a hardware processor, for example, to constitute a particular module at one instance of time and to constitute a different component at a different instance of time.

Machine (e.g., computer system) 500 may include one or more hardware processors, such as processor 502. Processor 502 may be a central processing unit (CPU), a graphics processing unit (GPU), a hardware processor core, or any combination thereof. Machine 500 may include a main memory 504 and a static memory 506, some or all of which may communicate with each other via an interlink (e.g., bus) 508. Examples of main memory 504 may include Synchronous Dynamic Random-Access Memory (SDRAM), such as Double Data Rate memory, such as DDR4 or DDR5. Interlink 508 may be one or more different types of interlinks such that one or more components may be connected using a first type of interlink and one or more components may be connected using a second type of interlink. Example interlinks may include a memory bus, a peripheral component interconnect (PCI), a peripheral component interconnect express (PCIe) bus, a universal serial bus (USB), or the like.

The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 616, a signal generation device 518 (e.g., a speaker), a network interface device 520, and one or more sensors 521, such as a global positioning system (GPS) sensor, compass, accelerometer, or other sensor. The machine 500 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 on which is stored one or more sets of data structures or instructions 624 (e.g., software) embodying or utilized by any one or more of the techniques or functions described herein. The instructions 624 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 624.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 524 may further be transmitted or received over a communications network 526 using a transmission medium via the network interface device 520. The machine 500 may communicate with one or more other machines wired or wirelessly utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks such as an Institute of Electrical and Electronics Engineers (IEEE) 802.11 family of standards known as Wi-Fi®, an IEEE 802.15.4 family of standards, a 5G New Radio (NR) family of standards, a Long Term Evolution (LTE) family of standards, a Universal Mobile Telecommunications System (UMTS) family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. In some examples, the network interface device 520 may wirelessly communicate using Multiple User MIMO techniques.

In addition, examples can include a device 600 having components to achieve the features disclosed herein. The device 600 may be an example configuration of machine 500—e.g., through hardware or software. For example, the device 600 can include a content share command identifier 602 that identifies a command to share content included in an application window executing on a first device. The application can be separate from a network-based communication application that provides the network-based communication session on the first device. The application can provide a user interface where the user interface can display the opened content while also including user interface controls. The device 600 can also have a data analyzer 604 that analyzes data of the application window.

The device 600 can also include a component 606 determining first and second content portions. In particular, the component 606 can analyze an application window to determine if the application window has different portions. A first portion can relate to content displayed by the application window. A second portion can relate to controls that can be used to control the content or the application window.

Moreover, the device 600 can have a content sharing window constructor component 608 that can be configured to construct a content sharing window based on the application window. The content sharing window constructor component 608 can construct the content sharing window by including the first portion of the application window into the content sharing window. Moreover, the content sharing window constructor component 608 can construct the content sharing window by excluding the second portion from the application sharing window from the content sharing window. The device 600 can also have a content sharing window resizer 610 that can resize a content sharing window using various interpolation methods, such as bicubic, bilinear, edge-directed, Fourier-based, or Nearest neighbor interpolation to size the content sharing window 400 to have the same area as the application window 302. The application 114 can also implement pixel-art scaling algorithms.

In addition, the device 600 can include a content sharing window transmitter 612 that can transmit a content sharing window. The constructed content sharing window can include the first portion of the application window. Moreover, the constructed content sharing window that is displayed at the second device does not include the second portion of the application window.

### Other Notes and Examples

Example 1 is a method for providing a content focus mode for screen sharing data during a network-based communication session, the network-based communication session between a first device and a second device, the method comprising: identifying, during the network-based communication session, a command to share content included in an application window of an application executing on the first device, the application being separate from a network-based communication application providing the network-based communication session on the first device; analyzing data of the application window; based on the analyzing, determining that the application window includes, a first portion that displays the content and a second portion that displays user interface controls, the user interface controls taking up areas of a user interface of the application where the content is not displayed, the user interface controls comprising a selection menu or control icons that, when an item of the selection menu or the control icons is selected, causes the first device to perform a function of the application corresponding to the item; constructing a content sharing window based on the application window by including the first portion of the application window into the content sharing window and excluding the second portion from the application window from the content sharing window, and transmitting display data of the constructed content sharing window including the first portion of the application window, but not the second portion of the application window, to the second device via the communication session.

In Example 2, the subject matter of Example 1 includes, wherein the method further comprises increasing a size of the first portion to a same size as both the first and second portions, the size large enough to occupy an entire area designated for screen sharing on the second device.

In Example 3, the subject matter of Examples 1-2 includes, wherein the user interface controls are configured to manipulate data within the first portion that displays the opened media within the application.

In Example 4, the subject matter of Examples 1-3 includes, where the method further comprises: identifying, during the network-based communication session, a command to share media opened by a second application window of a second application executing on the first device, the second application being separate from the network-based communication application providing the network-based communication session on the first device; analyzing data of the second application window; based on the analyzing, determining that the second application window includes a first portion that displays the content and a second portion that displays user interface controls, the second user interface controls taking up areas of a second user interface of the second application where the content is not displayed; and wherein constructing the content sharing window comprises including both the first portion of the application window and the first portion of the second application window and excluding both the second portion of the application window and the second portion of the second application window.

In Example 5, the subject matter of Example 4 includes, wherein the media corresponds to one of video, audio, a document, or a communication text string.

In Example 6, the subject matter of Examples 1-5 includes, receiving an instruction specifying that the screen share sharing data should be transmitted with the first portion that displays the content opened media within the application and not the second portion that displays user interface controls.

In Example 7, the subject matter of Examples 1-6 includes, receiving a first instruction specifying that the screen share sharing data should be transmitted with the first portion that displays the opened media within the application content and not the second portion that displays user interface controls for display at the second device; and receiving a second instruction specifying that instructions specifying that the screen share sharing data should be transmitted with the first portion that displays the opened media within the application content and not the second portion that displays user interface controls for display at the second device should be blocked at a third device.

In Example 8, the subject matter of Examples 1-7 includes, wherein the media corresponds to one of video, audio, a document, or a communication text string.

Example 9 is a computing device for providing a content focus mode for screen sharing data during a network-based communication session, the network-based communication session between a first device and a second device, the computing device comprising: a processor; a memory, storing instructions, which when executed by the processor cause the computing device to perform operations comprising: identifying, during the network-based communication session, a command to share content included in an application window of an application executing on the first device, the application being separate from a network-based communication application providing the network-based communication session on the first device; analyzing data of the application window; based on the analyzing, determining that the application window includes, a first portion that displays the content and a second portion that displays user interface controls, the user interface controls taking up areas of a user interface of the application where the content is not displayed, the user interface controls comprising a selection menu or control icons that, when an item of the selection menu or the control icons is selected, causes the first device to perform a function of the application corresponding to the item, constructing a content sharing window based on the application window by including the first portion of the application window into the content sharing window and excluding the second portion from the application window from the content sharing window; and transmitting display data of the constructed content sharing window including the first portion of the application window, but not the second portion of the application window, to the second device via the communication session.

In Example 10, the subject matter of Example 9 includes, wherein the operations further comprise increasing a size of the first portion to a same size as both the first and second portions, the size large enough to occupy an entire area designated for screen sharing on the second device.

In Example 11, the subject matter of Examples 9-10 includes, wherein the user interface controls are configured to manipulate data within the first portion that displays the opened media within the application.

In Example 12, the subject matter of Examples 9-11 includes, wherein the operations further comprise: identifying, during the network-based communication session, a command to share media opened by a second application window of a second application executing on the first device, the second application being separate from the network-based communication application providing the network-based communication session on the first device; analyzing data of the second application window; based on the analyzing, determining that the second application window includes a first portion that displays the content and a second portion that displays user interface controls, the second user interface controls taking up areas of a second user interface of the second application where the content is not displayed; and wherein constructing the content sharing window comprises including both the first portion of the application window and the first portion of the second application window and excluding both the second portion of the application window and the second portion of the second application window.

In Example 13, the subject matter of Examples 9-12 includes, wherein the operations further comprise receiving an instruction specifying that the screen share data should be transmitted with the first portion that displays the opened media within the application and not the second portion that displays user interface controls.

In Example 14, the subject matter of Examples 9-13 includes, wherein the operations further comprise: receiving a first instruction specifying that the screen sharing data should be transmitted with the first portion that displays the content and not the second portion for display at the second device; and receiving a second instruction specifying that instructions specifying that the screen sharing data should be transmitted with the first portion that displays the content and not the second portion should be blocked at a third device.

Example 15 is a device for providing a content focus mode for screen sharing data during a network-based communication session, the network-based communication session between a first device and a second device, the device comprising: means for identifying, during the network-based communication session, a command to share content included in an application window of an application executing on the first device, the application being separate from a network-based communication application providing the network-based communication session on the first device; means for analyzing data of the application window; means for, based on the analyzing, determining that the application window includes, a first portion that displays the content and a second portion that displays user interface controls, the user interface controls taking up areas of a user interface of the application where the content is not displayed, the user interface controls comprising a selection menu or control icons that, when an item of the selection menu or the control icons is selected, causes the first device to perform a function of the application corresponding to the item; means for constructing a content sharing window based on the application window by including the first portion of the application window into the content sharing window and excluding the second portion from the application window from the content sharing window; and means for transmitting display data of the constructed content sharing window including the first portion of the application window, but not the second portion of the application window, to the second device via the communication session.

In Example 16, the subject matter of Example 15 includes, wherein the device further comprises means for increasing a size of the first portion to a same size as both the first and second portions, the size large enough to occupy an entire area designated for screen sharing on the second device.

In Example 17, the subject matter of Examples 15-16 includes, wherein the user interface controls are configured to manipulate data within the first portion that displays the opened media within the application.

In Example 18, the subject matter of Examples 15-17 includes, wherein the device further comprises: means for identifying, during the network-based communication session, a command to share media opened by a second application window of a second application executing on the first device, the second application being separate from the network-based communication application providing the network-based communication session on the first device; means for analyzing data of the second application window; based on the analyzing, means for determining that the second application window includes a first portion that displays the content and a second portion that displays user interface controls, the second user interface controls taking up areas of a second user interface of the second application where the content is not displayed; and wherein constructing the content sharing window comprises including both the first portion of the application window and the first portion of the second application window and excluding both the second portion of the application window and the second portion of the second application window.

In Example 19, the subject matter of Examples 15-18 includes, wherein the device further comprises means for receiving an instruction specifying that the screen sharing data should be transmitted with the first portion that displays the content and not the second portion.

In Example 20, the subject matter of Examples 15-19 includes, wherein the device further comprises: means for receiving a first instruction specifying that the screen sharing data should be transmitted with the first portion that displays the content and not the second portion for display at the second device receiving a first instruction specifying that the screen share data should be transmitted with the first portion that displays the opened media within the application and not the second portion that displays user interface controls for display at the second device; and means receiving a second instruction specifying that instructions specifying that the screen sharing data should be transmitted with the first portion that displays the content and not the second portion should be blocked at a third device for receiving a second instruction specifying that instructions specifying that the screen share data should be transmitted with the first portion that displays the opened media within the application and not the second portion that displays user interface controls for display at the second device should be blocked at a third device.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20. Example 24 is a method to implement of any of Examples 1-20.

1. A method for providing a content focus mode for screen sharing data during a network-based communication session, the network-based communication session between a first device and a second device, the method comprising:
identifying, during the network-based communication session, a command to share content included in an application window of an application executing on the first device, the application being separate from a network-based communication application providing the network-based communication session on the first device;
analyzing data of the application window;
based on the analyzing, determining that the application window includes a first portion that displays the content and a second portion that displays user interface controls, the user interface controls taking up areas of a user interface of the application where the content is not displayed, the user interface controls comprising a selection menu or control icons that, when an item of the selection menu or the control icons is selected, causes the first device to perform a function of the application corresponding to the item;
constructing shared screen video data of the application window by including the first portion of the application window and by removing areas occupied by the second portion from the shared screen video data of the application window;
transmitting the shared screen video data including the first portion of the application window, but not the second portion of the application window, to the second device via the communication session; and
causing the second device to display a video of the shared screen video data of the application window, wherein the screen share video data is configured to cause the second device to display the video of the application window without the second portion.

2. The method of claim 1, wherein the method further comprises increasing a size of the first portion in the displayed content sharing window to a size larger than a display size of the first portion in the application window of the application executing on the first device.

3. The method of claim 1, wherein the user interface controls are configured to manipulate data within the first portion that displays opened media within the application.

4. The method of claim 1, where the method further comprises:
identifying, during the network-based communication session, a command to share media opened by a second application window of a second application executing on the first device, the second application being separate from the network-based communication application providing the network-based communication session on the first device;
analyzing data of the second application window;
based on the analyzing, determining that the second application window includes a first portion that displays the content and a second portion that displays user interface controls, the second user interface controls taking up areas of a second user interface of the second application where the content is not displayed; and
wherein constructing the content sharing window comprises including both the first portion of the application window and the first portion of the second application window and excluding both the second portion of the application window and the second portion of the second application window and the media corresponds to one of video, audio, a document, or a communication text string.

5. (canceled)

6. The method of claim 1, further comprising receiving an instruction specifying that the screen sharing data should be transmitted with the first portion that displays the content and not the second portion.

7. The method of claim 1, further comprising:
receiving a first instruction specifying that the screen sharing data should be transmitted with the first portion that displays the content and not the second portion for display at the second device; and
receiving a second instruction specifying that instructions specifying that the screen sharing data should be transmitted with the first portion that displays the content and not the second portion should be blocked at a third device.

8. (canceled)

9. A computing device for providing a content focus mode for screen sharing data during a network-based communication session, the network-based communication session between a first device and a second device, the computing device comprising:
a processor;
a memory, storing instructions, which when executed by the processor cause the computing device to perform operations comprising:
identifying, during the network-based communication session, a command to share content included in an application window of an application executing on the first device, the application being separate from a network-based communication application providing the network-based communication session on the first device;
analyzing data of the application window;
based on the analyzing, determining that the application window includes a first portion that displays the content and a second portion that displays user interface controls, the user interface controls taking up areas of a user interface of the application where the content is not displayed, the user interface controls comprising a selection menu or control icons that, when an item of the selection menu or the control icons is selected, causes the first device to perform a function of the application corresponding to the item;
constructing shared screen video data of the application window by including the first portion of the application window and by removing areas occupied by the second portion from the shared screen video data of the application window;
transmitting the shared screen video data including the first portion of the application window, but not the second portion of the application window, to the second device via the communication session; and
causing the second device to display a video of the shared screen video data of the application window, wherein the screen share video data is configured to cause the second device to display the video of the application window without the second portion.

10. The computing device of claim 9, wherein the operations further comprise increasing a size of the first portion in the displayed content sharing window to a size larger than a display size of the first portion in the application window of the application executing on the first device and the user interface controls are configured to manipulate data within the first portion that displays opened media within the application.

11. (canceled)

12. The computing device of claim 9, wherein the operations further comprise:
identifying, during the network-based communication session, a command to share media opened by a second application window of a second application executing on the first device, the second application being separate from the network-based communication application providing the network-based communication session on the first device;
analyzing data of the second application window;
based on the analyzing, determining that the second application window includes a first portion that displays the content and a second portion that displays user interface controls, the second user interface controls taking up areas of a second user interface of the second application where the content is not displayed; and
wherein constructing the content sharing window comprises including both the first portion of the application window and the first portion of the second application window and excluding both the second portion of the application window and the second portion of the second application window.

13. The computing device of claim 9, wherein the operations further comprise receiving an instruction specifying that the screen sharing data should be transmitted with the first portion that displays the content and not the second portion.

14. The computing device of claim 9, wherein the operations further comprise:
receiving a first instruction specifying that the screen sharing data should be transmitted with the first portion that displays the content and not the second portion for display at the second device; and
receiving a second instruction specifying that instructions specifying that the screen sharing data should be transmitted with the first portion that displays the content and not the second portion should be blocked at a third device.

15. A device for providing a content focus mode for screen sharing data during a network-based communication session, the network-based communication session between a first device and a second device, the device comprising:
means for identifying, during the network-based communication session, a command to share content included in an application window of an application executing on the first device, the application being separate from a network-based communication application providing the network-based communication session on the first device;
means for analyzing data of the application window;
means for, based on the analyzing, determining that the application window includes a first portion that displays the content and a second portion that displays user interface controls, the user interface controls taking up areas of a user interface of the application where the content is not displayed, the user interface controls comprising a selection menu or control icons that, when an item of the selection menu or the control icons is selected, causes the first device to perform a function of the application corresponding to the item;
means for constructing shared screen video data of the application window by including the first portion of the application window and by removing areas occupied by the second portion from the shared screen video data of the application window;
means for transmitting the shared screen video data including the first portion of the application window, but not the second portion of the application window, to the second device via the communication session; and
means for causing the second device to display a video of the shared screen video data of the application window, wherein the screen share video data is configured to cause the second device to display the video of the application window without the second portion.

16. The device of claim 15, wherein the device further comprises means for increasing a size of the first portion in the displayed content sharing window to a size larger than a display size of the first portion in the application window of the application executing on the first device.

17. The device of claim 15, wherein the user interface controls are configured to manipulate data within the first portion that displays opened media within the application.

18. The device of claim 15, wherein the device further comprises:
means for identifying, during the network-based communication session, a command to share media opened by a second application window of a second application executing on the first device, the second application being separate from the network-based communication application providing the network-based communication session on the first device;
means for analyzing data of the second application window;
based on the analyzing, means for determining that the second application window includes a first portion that displays the content and a second portion that displays user interface controls, the second user interface controls taking up areas of a second user interface of the second application where the content is not displayed; and
wherein constructing the content sharing window comprises including both the first portion of the application window and the first portion of the second application window and excluding both the second portion of the application window and the second portion of the second application window.

19. The device of claim 15, wherein the device further comprises means for receiving an instruction specifying that the screen sharing data should be transmitted with the first portion that displays the content and not the second portion.

20. The device of claim 15, wherein the device further comprises:
means for receiving a first instruction specifying that the screen sharing data should be transmitted with the first portion that displays the content and not the second portion for display at the second device; and
means receiving a second instruction specifying that instructions specifying that the screen sharing data should be transmitted with the first portion that displays the content and not the second portion should be blocked at a third device.

21. The method of claim 1 wherein the content has an indicia set therein and the method further comprises analyzing the indicia to determine a status of areas occupied by the second portion in the application window, the status indicating that the areas occupied by the second portion are to be removed from the application window, wherein constructing the content sharing window is based on analyzing the indicia and the status.

22. The method of claim 21, wherein the indicia is a Hypertext Markup Language tag.

23. The method of claim 1 wherein the content sharing window is resized without the second portion that displays the user interface controls
